(19) United States
(12) Patent Application Publication
(10) Pub. No.: US 2013/0060811 A1
(43) Pub. Date: Mar. 7, 2013

(54) System and Method for Operating Mobile Applications According to Activities and Associated Actions

(71) Applicant: Charles E. DIRCKS, Buffalo, IN (US)

(72) Inventor: Charles E. DIRCKS, Buffalo, IN (US)

(73) Assignee: MOBILE SAIL, LLC, St. Michael (BB)

(21) Appl. No.: 13/599,835

(22) Filed: Aug. 30, 2012

Related U.S. Application Data
(60) Provisional application No. 61/530,505, filed on Sep. 2, 2011.

(51) Int. Cl. G06F 17/30

(52) U.S. Cl. 707/770; 707/E17.014

(57) ABSTRACT

A system and method are provided, the method comprising: determining an activity; determining at least one action to be executed in connection with the activity; generating a database entry to include an activity action element specifying the activity and the at least one action; enabling the database entry to be accessed in response to an input; retrieving the activity action element; and executing the at least one action, the at least one action being associated with a mobile application. A method is also provided comprising: receiving an input; using information in the input to query a database of activity action elements each specifying an activity and at least one action to be executed in connection with the activity, the at least one action being associated with a mobile application; obtaining at least one activity action element from the database; and executing at least a first activity action element.

This application claims priority from U.S. Provisional Application No. 61/530,505 filed on Sep. 2, 2011, the entire contents of which are incorporated herein by reference.

### TECHNICAL FIELD

The following relates to systems and methods for operating mobile applications according to activities and associated actions.

### DESCRIPTION OF THE RELATED ART

Electronic devices, particularly portable or handheld devices such as smart phones, tablet computers, portable gaming devices, in-vehicle navigation systems and the like, continue to become more powerful and intelligent with ever more sophisticated applications being developed to run on such devices.

Despite the ability to have dozens, or even thousands of applications running on an electronic device, typically very few applications are related to each other, and data used by one application is local to that application. Similarly, installation, upgrading, and other administrative tasks associated with each application is typically performed individually and may not be portable when new devices are purchased and used.

### BRIEF DESCRIPTION OF THE DRAWINGS

Embodiments will now be described by way of example only with reference to the appended drawings wherein:

FIG. 1 is a schematic diagram illustrating a group, role, activity, and action relationship structure;

FIG. 2 is a schematic diagram illustrating generation of activity action database elements by generating group role and activity action keys for identifying the database elements;

FIG. 3 is a schematic diagram of a database processor interacting with an activity action database to utilize activity action database elements for operating mobile applications;

FIG. 4 is a schematic diagram of an example communication system for operating mobile applications using a cross application communication system (CACS);

FIG. 5 is a schematic diagram of an example communication system using client and server applications communicating over a network;

FIG. 6 is a block diagram of an example of a configuration for a CACS;

FIG. 7 is a flow diagram illustrating example computer executable instructions that may be performed in activating and interacting with CACS compatible applications to utilize activity action database elements from an activity action database;

FIG. 8 is a flow diagram illustrating example computer executable instructions that may be performed in enabling new activities to be generated, added to an activity action database, and information related to the new activities pushed to identity matches by querying the activity action database;

FIG. 9 is a flow diagram illustrating example computer executable instructions that may be performed in executing activity actions;

FIG. 10 is a screen shot of a cross application user interface;

FIG. 11 is a screen shot of a cross application user interface displaying a personal management welcome page;

FIG. 12 is a screen shot of a cross application user interface displaying a personal management page;

FIG. 13 is a screen shot of a cross application user interface displaying a rewards applications page;

FIG. 14 is a screen shot of a cross application user interface displaying an entertainment applications page;

FIG. 15 is a screen shot of a cross application user interface displaying a social applications page;

FIG. 16 is a screen shot of a cross application user interface displaying a mobile banking sign-on page;

FIG. 17 is a screen shot of a cross application user interface displaying a mobile banking applications page;

FIG. 18 is a screen shot of a cross application user interface displaying a mobile banking deposits set-up page;

FIG. 19 is a screen shot of a cross application user interface displaying a mobile shopping applications page;

FIG. 20 is a screen shot of a cross application user interface displaying a shops and offers page;

FIG. 21 is a screen shot of a cross application user interface displaying a your offers page;

FIG. 22 is a screen shot of a cross application user interface displaying an online purchase page for a mobile shopping application;

FIG. 23 is a screen shot of a cross application user interface displaying an at-location purchase for a mobile shopping application;

FIG. 24 is a screen shot of a travel application user interface displaying a mobile concierge page;

FIG. 25 is a screen shot of a travel application user interface displaying a user information entry page;

FIG. 26 is a screen shot of a travel application user interface displaying a user login page;

FIG. 27 is a screen shot of a travel application user interface displaying an activation confirmation page;

FIG. 28 is a screen shot of a travel application user interface displaying a wish list selection page;

FIG. 29 is a screen shot of a travel application user interface displaying a tours selection page;

FIG. 30 is a screen shot of a travel application user interface displaying a list of selectable tours;

FIG. 31 is a screen shot of a travel application user interface displaying a selected tour;

FIG. 32 is a screen shot of a travel application user interface displaying a notification page;

FIG. 33 is a screen shot of a travel application user interface displaying a notification page with options revealed;

FIG. 34 is a screen shot displaying an avatar in a virtual environment interacting with the virtual environment; and

FIG. 35 is a screen shot displaying the avatar of FIG. 30 subsequent to an action being performed in response to an activity initiated in the virtual environment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It has been recognized that by capturing, storing, and referencing elements that specify activities and associated actions, a mobile platform can be provided which enables both seamless processing across multiple applications, and seamless interactions with an identity across various devices, applications, and instances of the identity. By binding such activity action elements to the identity and, if applicable, groups and roles within such groups, an entire mobile ecosystem can be built for various applications and uses.

A cross application communication system (CACS) is herein described, which provides a mechanism by which activities and interactions with and between mobile applications can be captured, processed, and acted upon to allow an identity to achieve goals and desires and move between applications and devices while maintaining the coherency of the identity.

The activity action elements herein described provide multi-dimensional data records that can be drawn upon to instantiate a mobile identity for a real-world user or virtual avatar or character, facilitate daily activities and perform associated actions for such identities, and push data and information for newly created activities out to established identities. In this way, a bi-directional propagation of information, e-commerce, and other data flows can be provided throughout a connected environment, using one or more CACS as a central entity to manage these data flows.

The activity action elements may be maintained in one or more centrally controlled databases to allow various mobile applications running on various devices to take advantage of the activity action elements by communicating with one or more CACSs. The activity action elements may therefore be accessed by applications on any enabled device, e.g., to begin a purchase on one device to be completed on another device, to participate in online gaming using the same character on any enabled device, etc. Enabled applications can also be reinstalled, upgraded, or degraded in order to return an application to a previous state and to facilitate replacement of devices. Therefore, not only can activities associated with an identity such as a user seamlessly be created and re-created on any device, activity action elements can be linked or otherwise programmed to trigger dynamic and/or multi-dimensional responses on an enabled device or elsewhere in the system according to interactions with a particular enabled application, or the CACS and/or database directly, as will be explained in greater detail below.

Group and role information can also add another layer to the activity action elements to not only associate such elements with an identity, but also a group of identities. Role information can be used to allow or deny certain actions associated with a particular activity to provide further flexibility in the way identities are linked and can communicate throughout the system. For example, a family-based group may enforce a hierarchy of administrative rights and action permissions to allow, for example, information pushed to an identity to be propagated throughout a group (e.g., down or up the hierarchy) or an initiated activity to provide certain actions for those higher up a hierarchy while limiting actions further down the hierarchy.

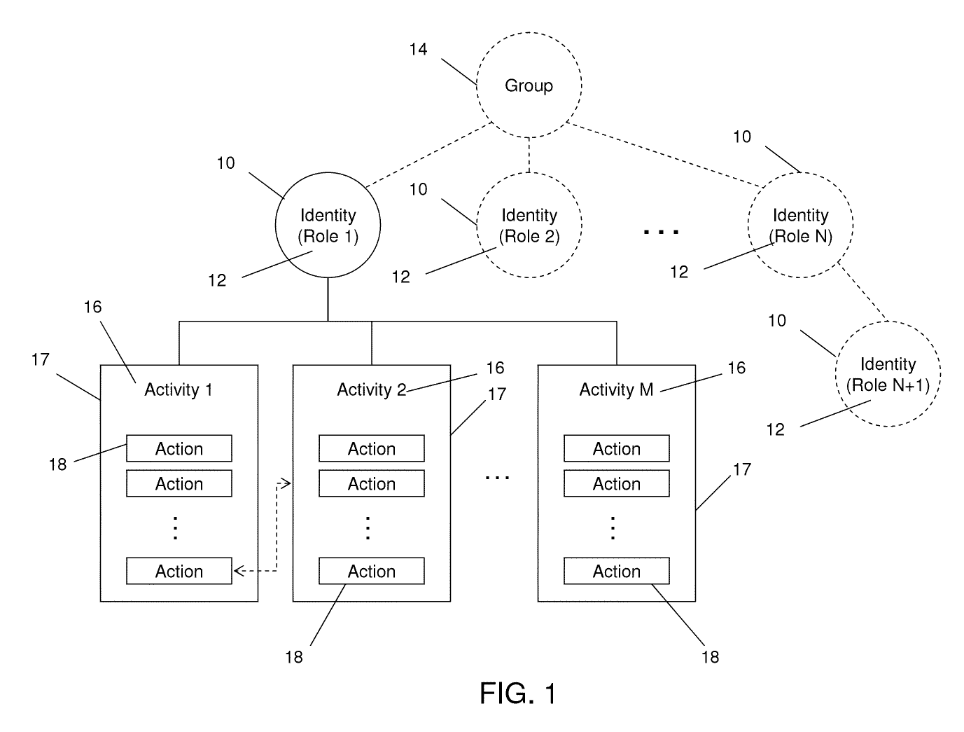

Turning now to the figures, FIG. 1 illustrates a group-role-activity-action structure to illustrate the relationships between activity action elements 17 (comprising activities 16 and associated actions 18), identities 10 to which the activity action elements 17 may relate, and, if applicable, the role 12 of the identity 10 within a group 14, which may have a hierarchy (e.g., Role N+1 being subordinate to Role N). It can be appreciated that the dashed lines in FIG. 1 illustrate that the placement of an identity 10 within a group 14 is entirely optional (i.e. groups of one identity 10 may exist). It can also be appreciated that an activity action element 17 may also exist on its own and/or the same activity action element 17 may be linked or otherwise associated with multiple identities 12, roles 14, and groups 14.

As also shown in FIG. 1, certain actions 18 performed in association with or in response to an activity 16 may trigger other activities 16. For example, a purchase made using an enabled application (activity 16) may include an online purchase (action 18), that in turn triggers a new activity 16 within a banking system, e.g., a payment authorization or account update. The activity action elements 17 therefore provide a data structure that allows one or more actions 18 to be triggered or initiated upon detecting or performing an activity 16 or otherwise being instructed that an activity 16 has taken place. The group-role structure may be used to add another layer such that the same activity 16 can have different “levels” or variations of actions 18 according to the role 12 of a related identity 10. Similarly, a collection of activity action elements 17 may be inhibited for certain roles 12 while allowed for those higher in the group hierarchy.

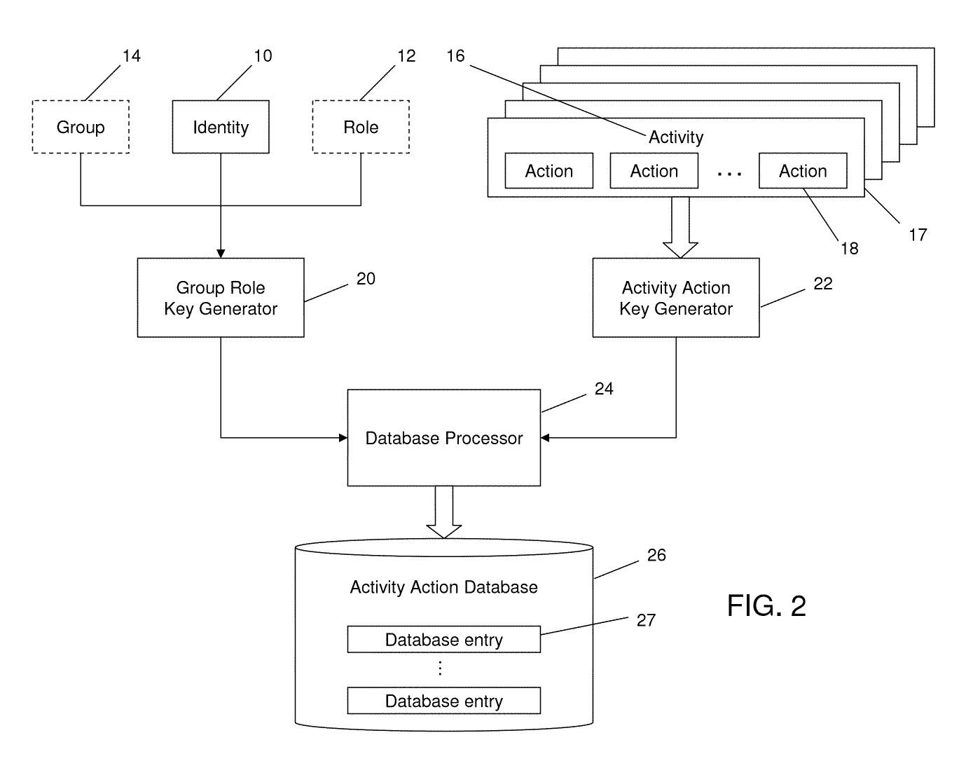

FIG. 2 illustrates the generation of database entries 27 to be stored and later accessed and referenced from an activity action database 26. A database processor 24 is provided, which may be used to generate keyed or otherwise identifiable characteristics to be incorporated into the database entries 27 such that activity action elements 17, from which the database entries 27 are generated, can be found, associated with particular identities 10, groups 14, roles 12, etc., and acted upon to trigger a new activity 16 or, based on a detected activity 16, determine the associated action(s) 18. The database processor 24 therefore not only generates and populates the activity action database 26, but also queries and modifies the activity action database 26 as required and/or requested. The database processor 24 in the example shown, generates database entries 27 based on keyed portions of data generated by a group role key generator 20 and an activity action key generator 22.

The group role key generator 20 is responsible for incorporating the identity 10 and, if applicable, any group 14 and role 12 related information. The group role key generator 20 therefore enables activity action elements 17, also to be included or otherwise identified in the database entry 27, to be associated with an identity 10 in the overall system. The group role key generator 20 also enables the role 12 of the identity 10 within a group 14 to be incorporated into the database entry 27. Moreover, multiple identities 10 in a group 14, with various roles 12 can also be specified in a particular database entry 27 such that by cross referencing an activity 16 to the associated group-role information allows for varied actions 18 to be performed based on the role 12 within the group or other interrelationships between multiple identities 10.

The activity action key generator 22 may be used to create a unique database entry 27 for a particular activity action element 17 that can be queried at a later time by the database processor 24. It can be appreciated that the key generators 20, 22 may utilize any suitable technique to generate the keyed portions of the database entries 27, for example, hashing. It can also be appreciated that separate key generators 20, 22 are shown in FIG. 2, and shown independent on the database processor 24 for illustrative purposes only. For example, the functionality of the key generators 20, 22 may also be incorporated into the functionality of the database processor 24.

The database processor 24 combines the identity 10 and, if applicable, group 14 and role 12 information processed by the group role key generator 20, with the activity action element 17 information processed by the activity action key generator 22 to create a unique database entry 27 for the activity action database 26. The database entry 27 can thereafter be queried to determine activities 16 and associated actions 18 and, as applicable, identities 10, groups 14, and roles 12 that may affect the processing of the activity action elements 17. It can be appreciated that database entries 27 may be generated that are generic to detectable activities without any specific association with any particular identities 10. In this way, the activity action database 26 can also define fundamental operations, e.g., inter-application operations that can be initiated based on a detected activity 16, regardless of the identity 10 that is interacting with the system. Such identity-less database entries 27 can be used, for example, to process new identities 10 or to bring identities 10 and businesses together where a previous relationship did not exist. For example, an identity 10 that is associated with a mobile user that uses a system-enabled web browser may select an advertisement in a webpage, which queries the activity action database 26 to find a coupon or other offer for the identity 10, thus enabling a new relationship to be established. If the user then interacts with the coupon or offer, new activity action elements 17 may be generated and/or accessed based on the interaction.

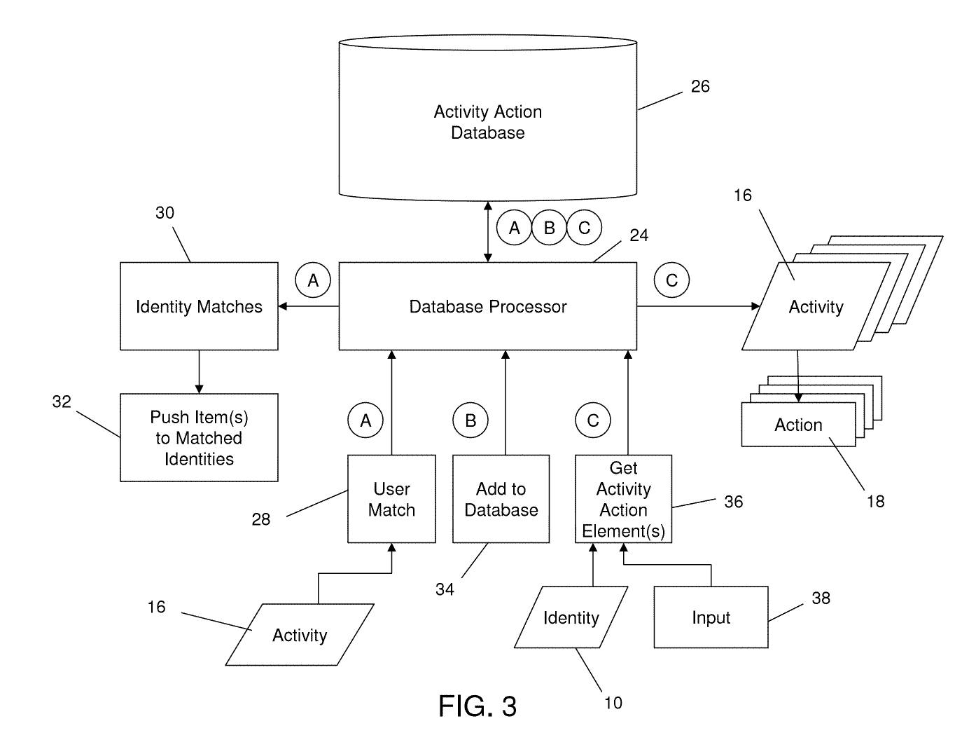

FIG. 3 illustrates example interactions with the activity action database 26 using the database processor 24. Interaction A shown in FIG. 3 includes a user match 28 based on a particular activity 16. For example, a business may have an offer for a product that is specified by, or otherwise relatable to various user identities 10 as specified in a number of database entries 27. This allows the user match 28 process to be applied to detect a number of users to which the business can push an offer or advertisement. The database processor 24 queries the activity action database 26 to determine appropriate identity matches 30, which can be pushed to the matched identities at 32. It can be appreciated that the activity 16 shown in FIG. 3 may have associated actions 18 that are stored in the activity action database 26, e.g., as an identity-less or generic database entry 27 such that after pushing the items out to the matched identities, further interactions with the items may cause those associated actions 18 to be triggered.

Interaction B shown in FIG. 3 includes an add to database process 34 which, as discussed above, generates new activity action element 17 based database entries 27, with identity 10 and group 14 and role 12 information included as appropriate. The add to database process 34 can be used in many ways to create new database entries 27 in various circumstances, for example, after detecting an interaction with an enabled mobile application, after detecting a new identity and/or newly installed application, etc.

Interaction C shown in FIG. 3 includes a get activity action element process 36. In this example, based on an identity 10 and other input 38 such as contextual information, application information, etc.; the get activity action element process 36 queries the activity action database 26 to return appropriate activities 16 and associated actions 18 to be performed. For example, an identity 10 that is associated with a virtual character or avatar may have characteristics such as clothing, hairstyles, etc. that are added to the avatar when an online game or application is initiated or based on a new level or scene in the game or application. The activity action database 26 therefore provides a central repository of activities 16 and actions 18 that can be consistently applied to identities 10 in a mobile ecosystem to allow the same identity 10 to be used in any enabled application and on any enabled device.

The database processor 24 and activity action database 26 allow centralized processing of identities 10 and any interaction that identity 10 may have with enabled components of a mobile system. The processing can be done in both directions, namely in one direction by identifying an activity 16 and matching that activity 16 to database entries 27 associated with identities 10 and pushing data and information out to those identities, and in the other direction by using an identity 10 and any related input 38 to identify relevant database entries 27 to be processed for that identity.

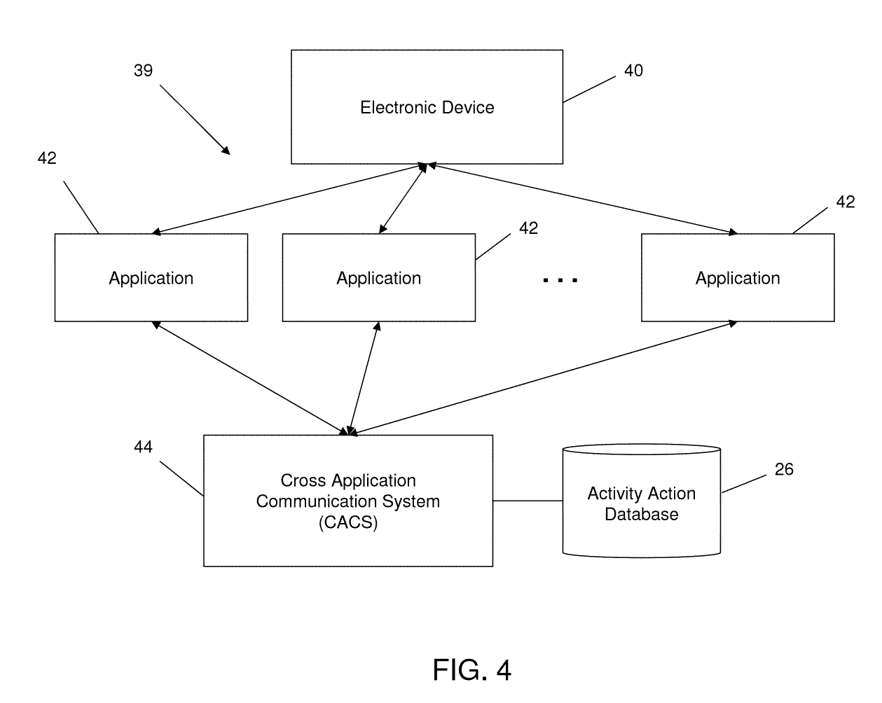

Turning now to FIG. 4, a mobile environment 39 is shown, in which an electronic device 40 may be used to interact with various applications 42. The applications 42 are enabled for communicating with a cross application communication system (CACS) 44 that coordinates and facilitates data flows throughout the mobile environment 39. The CACS 44 utilizes the activity action database 26 to allow cross application processing based on interactions between identities 10 and enabled applications 42 on enabled electronic devices 40. The applications 42 shown in FIG. 4 may be integrated into the mobile environment 39 in various ways. For example, existing applications 42 may be enabled by the CACS 44 wrapping its functionality around the existing application 42 such that the existing application 42 is unaware of its incorporation into the mobile environment 39. For example, an online banking application 42 for a particular bank account may be interacted with by the CACS 44 to facilitate a purchase being made using a CACS-enabled application 42.

The applications 42 may also be virtual applications 42 running on an electronic device 40 wherein the CACS 44 displays an icon and user interface elements on the electronic device 40 but the processing is performed by the CACS 44. In the above example, the CACS 44 may provide a banking front end that allows users to manage multiple accounts from a CACS-enabled user interface, and the processing and inter-application operations are handled by the CACS 44.

The applications 42 may also be programmed by an application developer to be CACS-enabled by taking advantage of APIs exposed by the CACS 44 and enabling the application 42 to generate custom activity action elements 17 for that application 42 and perform database queries via the CACS 44 without having to rely on the CACS 44 for all of the backend processing.

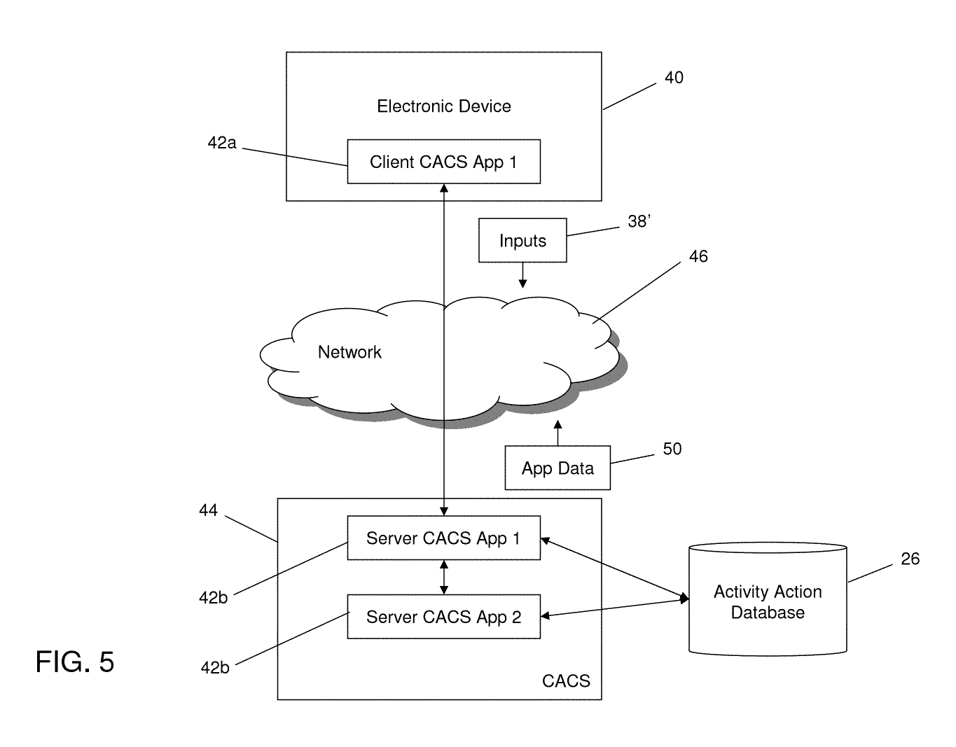

FIG. 5 illustrates one configuration for deploying an application 42 in the mobile environment 39 by having a client CACS application 42a running on the electronic device 40 and a server CACS application 42b running on the CACS 44. By having both client and server applications 42a, 42b, the CACS 44 can efficiently process inputs 38′ provided thereto over a network 46, from the electronic device 40, via one CACS client application 42a that includes communicating with both the activity action database 26 and other server CACS applications 42b (e.g., Server CACS App 2 shown in FIG. 5) and return application (app) data 50 to the client CACS application 42a in response to the inputs 38′. It can be appreciated that the configuration shown in FIG. 5 is only illustrative and various other configurations may be utilized. For example, a non-CACS enabled client application (not shown in FIG. 5) may have inputs 38′ intercepted on the electronic device 40 in order to have the CACS 44 process those inputs 38′ transparent to the non-CACS enabled application.

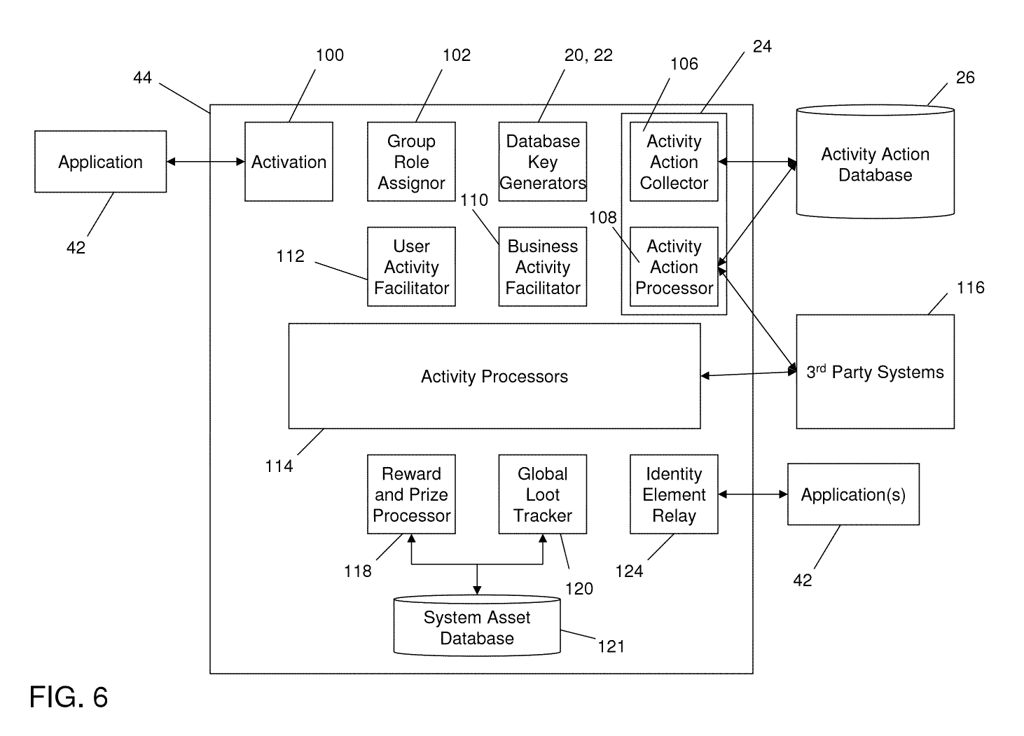

FIG. 6 illustrates an example of a configuration for the CACS 44. The CACS 44 in this example includes an activation component 100 that may interact with applications 42 to activate identities 10 and the applications 42 themselves, and a group role assignor 102, which may be used to specify group-role permissions and constraints and security for a particular identity 10. The database key generators 20, 22 are also shown, which enable new database entries 27 to be generated and stored in the activity action database 26. The database processor 24 is also shown in FIG. 6, which includes an activity action collector 106 for searching the activity action database 26 to assemble activity action elements 17 required for an activity action processor 108 to begin individual activity-action processing using various activity processors 114. The activity processors 114 may include various modules or components for handling different cross application functionality or task-specific functionality. The activity processors 114 may include, without limitation, a mall and shop supervisor, avatar generator, social group/club advisor, concierge, travel agent, business manager, personal and group manager, bank teller, etc. The activity processors 114 can not only communicate with each other, but also various external 3^{rd} party systems 116 such as systems related to banking, event tickets, airline reservations, hotel reservations, tour reservations, email, messaging, social media, etc.

A user activity facilitator 112 may be provided to process activities 16 associated with user-based identities and a business activity facilitator 110 may be used to process activities associated with business or organization-based identities. The user activity facilitator 112 is operated by the CACS 44 to resolve user-centric activity action events to ensure that focus is maintained on the identity 10 (e.g., user) to both prioritize actions 18 and resolve conflicting activities 16 and actions 18, e.g., according to importance, rarity, etc. Similarly, the business activity facilitator 110 is operated by the CACS 44 to resolve business-centric activity action events to ensure that a particular business or related organization's goals and objectives are managed and prioritized.

Activity action elements 17 used in a particular session or transaction may be processed and reconfigured by a reward and prize processor 118 to assign value items to an identity 10 (e.g., a user or business). System assets and transactions may also be tracked by a global loot tracker 120. The reward and prize processor 118 and global loot tracker 120 may be used in connection with a system asset database 121 to manage and balance assets within the system, such as real and virtual currencies, bartering, points, rewards, items won and acquired (loot), etc. It can be appreciated that the CACS 44 may have its own system asset database 121, which can be synchronized with similar databases in other CACSs 44 to provide global asset balancing across different environments. For example, a game that provides rewards that are convertible to real-word points (e.g., loyalty points) or currency can be synchronized with a CACS 44 servicing banking or rewards interactions. It can also be appreciated that the system asset database 121 is shown as a separate component for illustrative purposes only and may, for example, be an integral part of the activity action database 26 or other memory element.

An identity element relay 124 may also be provided, in communication with one or more applications 42, to pass activity action elements 17 back and forth between the CACS 44 and the applications 42.

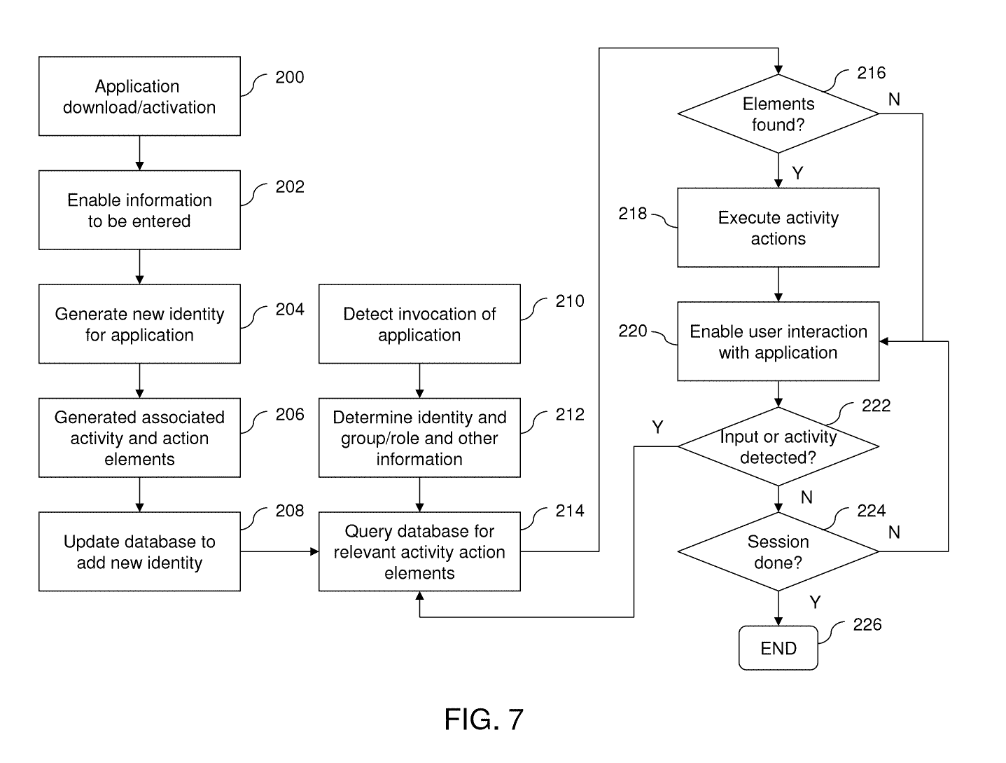

FIG. 7 provides a flow diagram illustrating example computer executable instructions that may be performed in activating and interacting with CACS compatible applications 42 to utilize database entries 27 from the activity action database 26. In the example shown in FIG. 7, interactions with the activity action database 26 are initiated in either activation scenarios or normal use of an application 42. At 200 an application download or activation is detected. For example, an electronic device 40 may already have a CACS-enabled application 42 installed thereon and when obtained by a user, an new identity 10 is activated. An enabled electronic device 40 such as a smart phone may also be capable of downloading a new CACS-enabled application 42 from the CACS 44 or any other application 42 that can be layered with the CACS-type functionality, e.g., from a 3^{rd} party application service. The application 42 is then registered or otherwise associated with one or more identities 10 that utilize the electronic device 40. At 202, information is entered into the application 42 to facilitate the activation or registration of an identity 10. The new identity 10 for that application 42, which may relate to an existing identity 10 known to the CACS 44, may then be generated at 204 and, based on the information that was entered, associated activity action elements 17 are generated at 206. For example, a travel application used at a vacation destination may allow a user to specify their goals and preferences to allow new activity action elements 17 to be generated that allow appropriate content and suggestions to be pushed to the new user identity 10.

The activity action database 26 is then updated at 208 to include the new identity 10 by adding associated database entries 27 related to the new identity 10. The addition of the new identity 10, e.g., upon registration, may also trigger a query of the activity action database 26 at 214 for relevant activity action elements 17 based on the information entered by the user and/or existing database entries 27 that could be relevant to the user and application 42. For example, after registering with a travel application at a vacation destination, a user profile can be used to match the user's wishes and goals with database entries 27 related to those goals, such as highly rated restaurants serving the type of food the user is interested in, etc.

As discussed above, an identity 10 and application 42 may already exist on an electronic device 40 and interactions with that application 42 can be tracked by the CACS 44 periodically or continuously to provide an ongoing, seamless mobile environment 39 for the identity 10. At 210, the invocation of an application 42 is detected and an identity 10 and, if necessary, group 14 and role 12 and any other relevant information are determined at 212. The application 42 may therefore be used by multiple identities 10 and can be tailored to provide an experience that is suitable for the particular identity 10, including relying on group 14 and role 12 information accordingly. When the application 42 is invoked and the identity 10 determined, the activity action database 26 may also be queried at 214 to determine relevant activity action elements 17.

At 216, the activity action processor 208 determines if any activity action elements 17 have been found. If so, the activities 16 and associated actions 18 are executed at 218. It can be appreciated that the activity action elements 17 executed at 218 in this example relate to items and features that are instantiated when a new application 42 is activated or downloaded or an existing application 42 is invoked, in order to bring the user back to a familiar state. For example, if the application 42 uses an avatar in a game, the query performed at 214 may be used to create a new character or add elements to the character based on a previous state. By storing activity action elements 17 as herein described, the application 42 can be used on any enabled device and the identity 10 can move between similar applications 42 while retaining the consistency of the identity 10. Once the application 42 and identity 10 are established, user interactions with the application are enabled at 220. The CACS 44 may then be notified of or otherwise detect input or activity in the application 42 by determining if there is detected input or activity at 222. If so, the activity action database 26 may be queried at 214 to determine if elements are found and operations 216, 218, and 220 repeated in a seamless and continuous fashion. If inputs and activities are not detected at 222, the CACS 44 determines if the session is done at 224 (e.g., whether or not the application 42 is still active). If not, user interactions may continue to be possible at 220. If the session has ended, the CACS 44 ends the session at its end and may perform any post processing, e.g., to reconfigure or add new activity action elements 17 based on the interactions detected during use of the application 42.

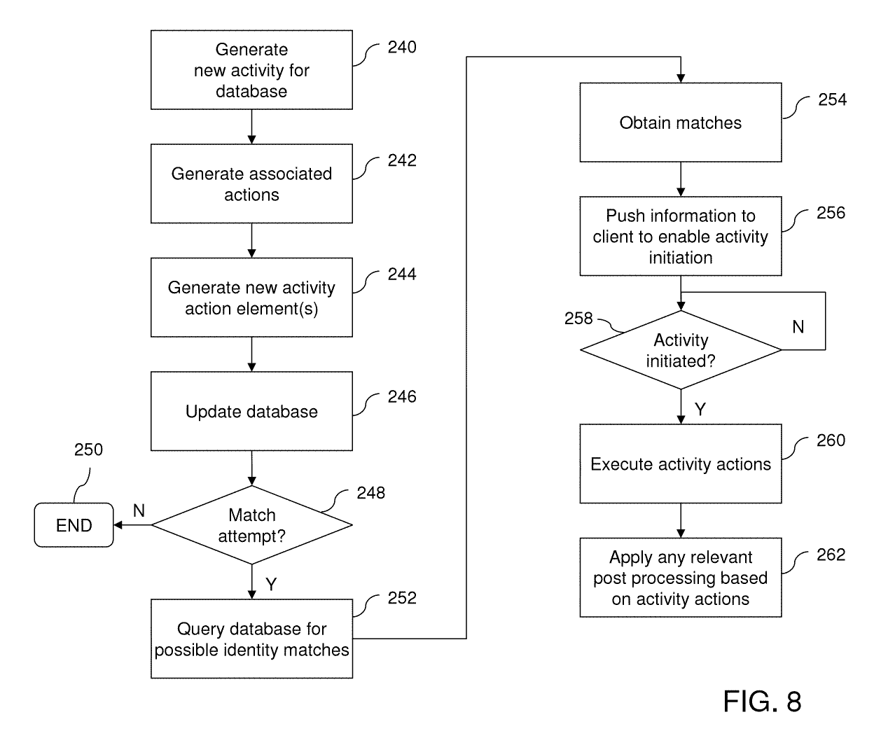

FIG. 8 provides a flow diagram illustrating example computer executable instructions that may be performed in enabling new activities 16 to be generated and added to the activity action database 26, and information related to the new activities 16 pushed to identity matches by querying the activity action database 26. At 240 a new activity 16 to be stored in the activity action database 26 is generated, e.g., by a business, identity 10, or other entity. At 242, actions 18 associated with the activity 16 are generated and new activity action element(s) 17 generated at 244. For example, a business may have an offer or sale to advertise and create a coupon activity 16 that, if used, triggers various actions 18 such as enabling an online purchase, crediting websites for click-thrus, paying commissions, etc. The activity action database 26 is then updated at 246 by adding new database entries 27. Upon creating the new activity action elements 17, or at a later time, the CACS 44 may determine at 248 whether or not the entity creating the new activity action elements 17 wishes to perform a match attempt to link the new activity 16 with existing identities 10 in the mobile environment 39. If not, the new database entry 27 is added without further action and the process ends at 250. If a match attempt is to be executed, the activity action database 26 is queried at 252 to determine possible identity matches for the new activity action element 17. The matches are then obtained at 254, and information may then be pushed to client applications 42a to enable the new activity action elements 17 to be presented to the matched identities 10. The CACS 44 determines or is otherwise notified whether or not activity is initiated based on the information pushed to the client applications 42a. If not, the process may loop while the information is available to the matched identities 10. If an activity 16 is initiated, e.g., a user selects to obtain a coupon made available to them, the actions 18 associated with the activity 16 are executed at 260 and any relevant post processing (e.g., further activity-action executions, global loot tracking, rewards processing, etc.) performed at 262.

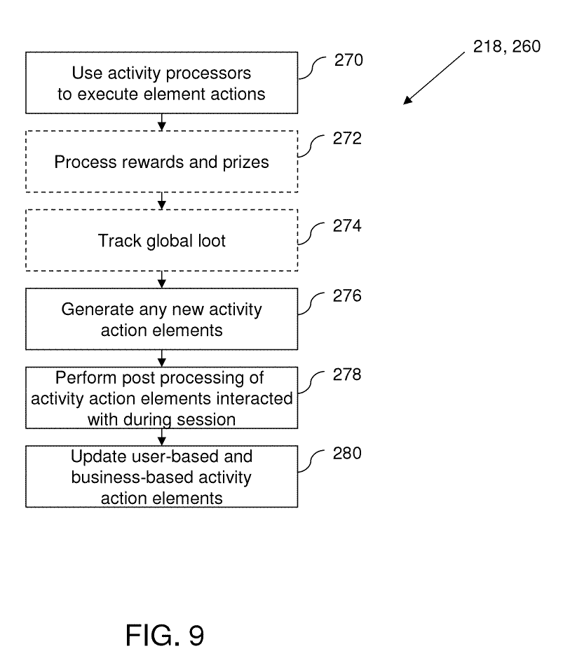

FIG. 9 provides a flow diagram illustrating example computer executable instructions that may be performed in executing activity actions 18, e.g., at 218 and 260 in FIGS. 7 and 8 respectively. At 270, the activity action processors 114 are used to execute element actions 18, which may include calling 3^{rd} party systems 116 to perform specific actions 18. Based on the executed actions 18 and, if applicable, rewards and prizes may be optionally processed by the reward and prize processor 118 at 272 to expose and manage rewards and prizes globally for the benefit of other applications 42. For example, asset balancing may be performed within or between CACSs 44. Similarly, global loot may be optionally tracked by the global look tracker 120 at 274, e.g., to balance and adjust system parameters for business-to-business transactions and the like. Based on the executed actions 18, the CACS 44 then generates any new activity action elements 17, which may be stored in the activity action database 26 and/or pushed out to relevant applications 42 by the identity element relay 124. For example one action 18 may trigger the generation of a new activity 16 for a particular identity 10. Post processing of the activity action elements that are interacted with during the session is then performed at 278 and user-based and business-based activity action elements 17 are updated, if necessary, at 280.

It can be appreciated that identities 10 can set, pursue, and achieve personal goals using CACS-enabled applications 42. This may be done by revisiting the activity processors 114 at 276, 278, and 280 with activity action elements 17 associated with a user's personal management elements to produce milestones and determine if and when a goal has been reached. Similarly, businesses can set, pursue, and achieve business intelligence, marketing, and product placement goals by revisiting the activity processors 114 with elements of, for example, product inventory, to process milestones and determine if and when a goal has been reached.

The activity action elements 17 can be varied to achieve different goals and/or to perform different functions in different applications 42. A few examples will now be described.

User management activity action elements 17 may be used to handle day-to-day user experiences, such as: (a) what you are allowed to do by the application 42—e.g., set permissions, inherit permissions, have roles 12, create groups 14, establish identities 10, track user activity and history, etc.; (b) user interactivity—e.g., with buddies, comments, business and user comments, evaluations, question and answer surveys, discussions, blogs, mail, audio and video, wish lists, opinions, wish documents, opinions, wish submissions, etc.

Communication activity action elements 17 may be used to handle activation, device identification, device/user authentication, creation of user relay sessions to establish communications for the electronic device 40 and the applications 42 (e.g., messaging user to user, business to user, application 42 to user, administrator to user, single user and group notifications from applications 42 or administrators), etc. Communications can be done across applications 42 or system wide for news, wire services, mail, chats, journals, comments and evaluations, etc. and may use standard protocols for conducting reservations, banking, social networking, etc.

Business management activity action elements 17 may be used for operations, sales and management, news applications to be deployed within the mobile environment 39, and integrating existing applications 42 into a business-related goal. This may include activity action elements 17 governing inventory, order processing, account tracking, restocking, sales status, sales outcome, reward point allocation, video content, audio content, static content, business activity, business set-up, administration rules, intelligence gathering, reporting, etc.

Social and shopping activity action elements 17 may be used for consumers and may include searches by any criteria, activity, hierarchy or permissions across applications 42, cross-referencing to inventory elements, assigned characteristics that tie products to uses, processes, user activities, categories (e.g., wear, listen, read, watch, restock, notify, etc.), retail businesses with inventory, cash shops (e.g., for consumers who wish to pay cash on e-transactions or do not have credit), virtual malls formed by multiple businesses or by category of interest, user shops for classified ads, trades to swap items with other users, balancing transactions with money and rewards, donations, user inventory to load or list products to sell, trade, donate, etc. Collections of inventory subdivisions, reward usage by loyalty systems, accruals, redemptions, etc. can also be managed. Games for communications between players, prizes, and awards from games and purchases, pets (both virtual and real), needs, supplies, displays, avatars for identity association, etc. can also be managed using activity action elements 17.

Personal management activity action elements 17 may also be provided for individuals and his/her group 14 with a goal to have a series of tasks completed with an end result, e.g. a Christmas gift list.

Financial management activity action elements 17 may be used to facilitate bank deposits, bank withdrawals, bank transfers, statements, auto bill payments, donation management, reward point engagement, asset tracking, and point of sale setup configuration.

An example of a data flow using activity action elements 17 will now be described. In the example to be described, a user accesses a smart phone intending to shop for and purchase a shirt. An enabled application 42 had previously added the same shirt to it inventory and attached activity action elements 17 with the shirt and stored one or more database entries 27 in the activity action database 26. The activity action elements 17 may include: wear-chest, color-blue, restock-below 5, ship-overnight, notify-soccer club, reward-10, prize-pants purchases, etc. When the purchase of the shirt takes place, the CACS 44 processes each of these activity action elements 17 and then proceeds to add additional activity action elements 17 related to the user, such as pay-account X, inventory-group soccer, goal-get uniform, etc. These elements 17 provide complete order facilitation to the business from banking to shipping to restocking while also facilitating the activities and goals of the user, e.g., by notifying the soccer club that the shirt has been purchased or later when the goal of getting the rest of the uniform has been achieved. The CACS 44 therefore lays a foundation of activity action elements 17 for any grouping of applications 42 that can/wish to communicate and route activity between them. In another example, a shopping cart can be provided for multiple enabled applications to facilitate the purchase of multiple items from different sources in seemingly a single transaction made by the user.

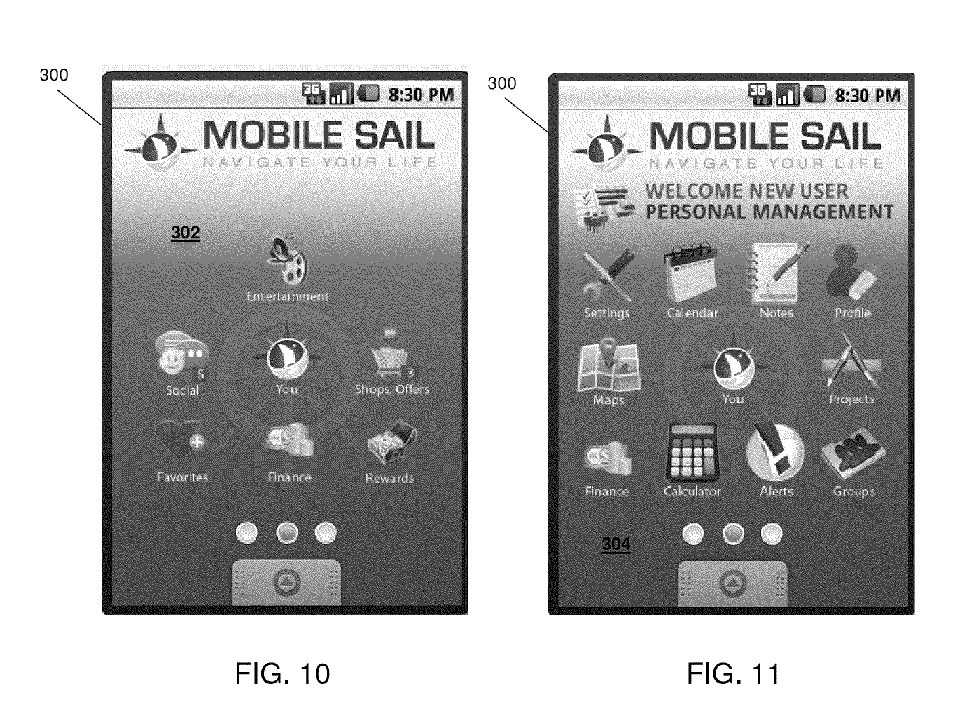

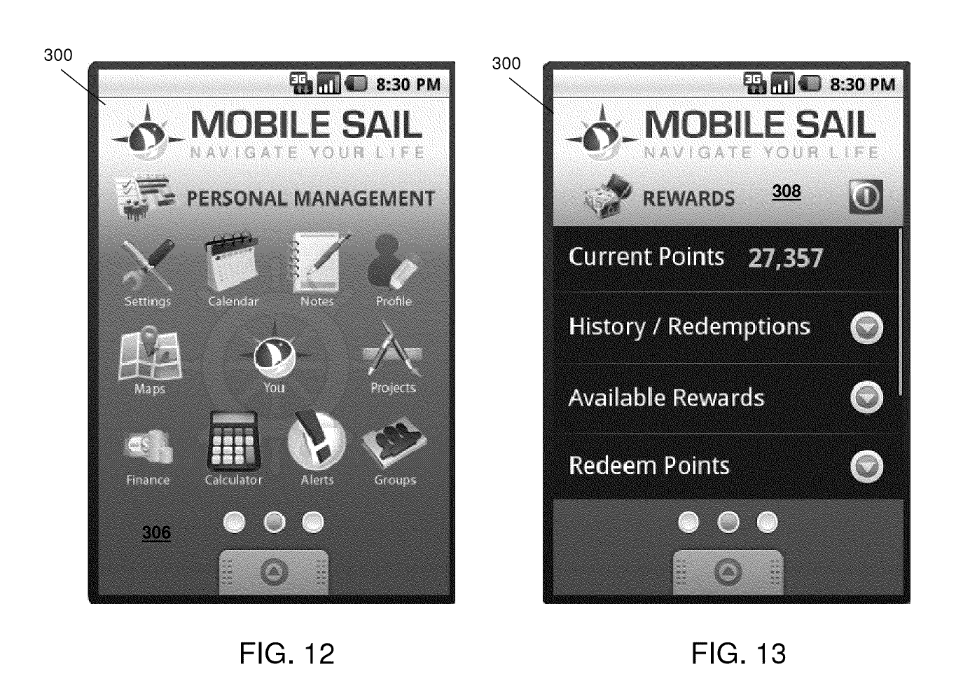

FIGS. 10 through 23 illustrate an example user interface 300 for a collection of enabled applications 42 on a mobile electronic device 40. As shown in FIG. 10, a personal page 302 may be centered around a particular user management application and can be configured for different identities 10. In the example shown, entertainment, social, shops, favorites, finance, and rewards are integrated into the personal page 302. By selecting the “You” icon in this example, a screen such as that shown in FIG. 11 may be displayed, which illustrates a welcome page 304 for a personal management application that illustrates additional application icons for enabled applications 42. FIG. 12 illustrates a personal management page 304 after registration. The personal management page 304 includes various applications that are managed via the CACS 44 to service one or more users. For example, the Notes application may include a “to do” list of tasks that the user is to complete. The CACS 44 can assign activity action elements 17 to the list items such that backend processes can be performed to assist with completing the tasks, and performed after the user completes the task and thus completes a goal. By connecting various enabled applications such as the calendar, profile, to do lists, projects, groups, etc., cross-application activities 16 and actions 18 can be facilitated and the activity action elements 17 provide a foundation on which the cross application communications are triggered, propagated, and executed. In another example, complex project management tools can be integrated into the CACS 44 and other applications, such as notes, to do, calendars, groups, etc. to provide a bridge between personal and business-related goals and tasks and to manage which activity action elements 17 are applied, under what circumstances, and according to which priorities.

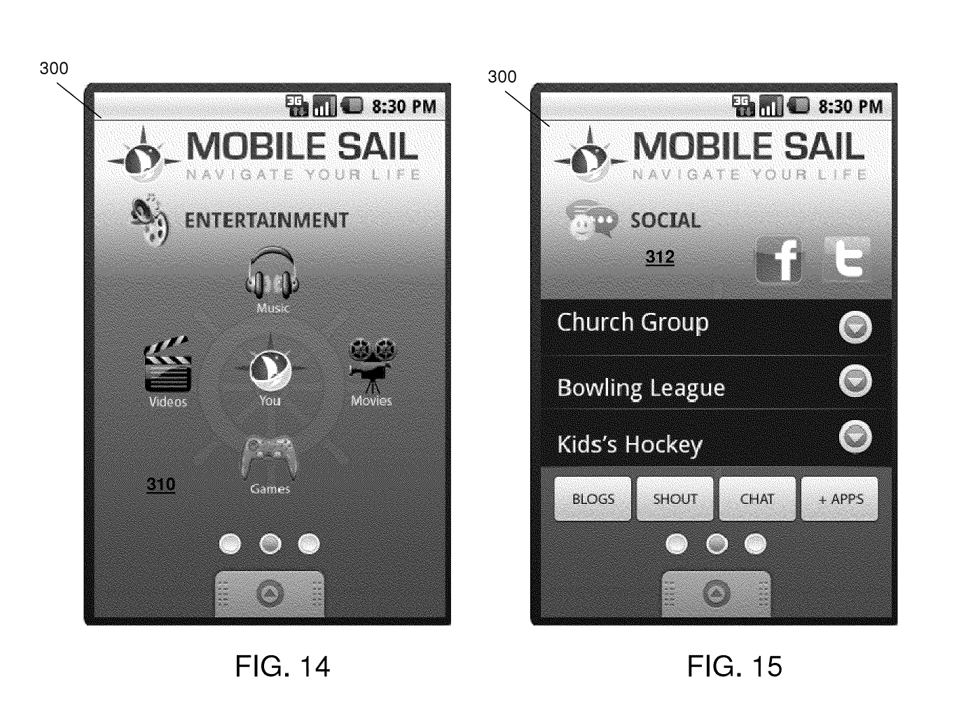

FIG. 13 illustrates an example of a rewards page 308, which can amalgamate points, manage different loyalty programs and facilitate redemptions and account histories for multiple loyalty programs. An entertainment page 310 is shown in FIG. 14, which enables entertainment related and enabled applications 42 to be linked together via the CACS 44. FIG. 15 shows a social page 312, which may also be used to bring together multiple related group and social applications 42.

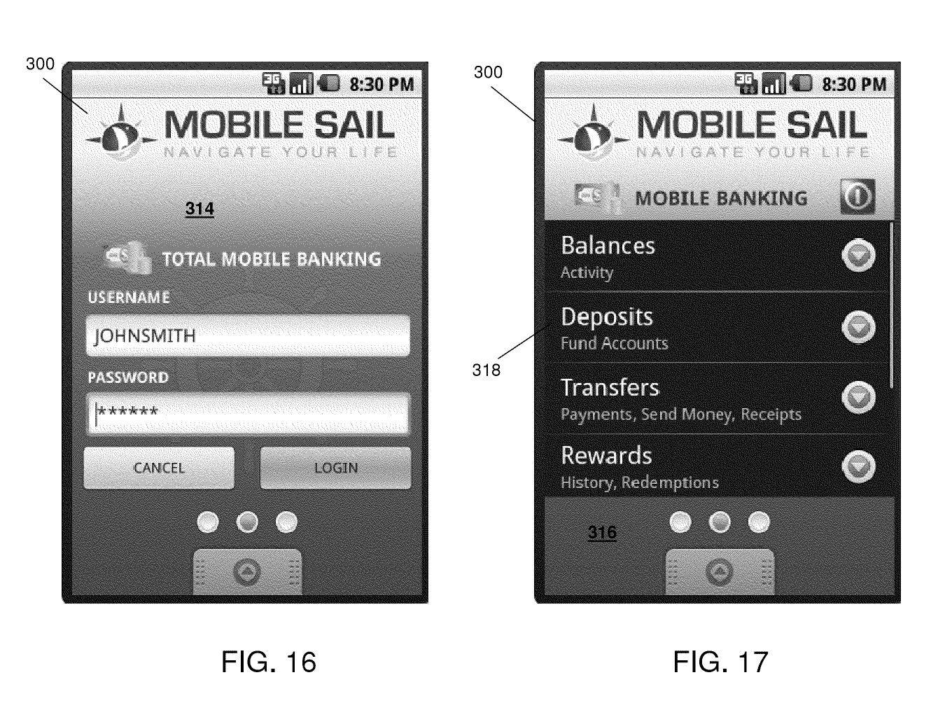

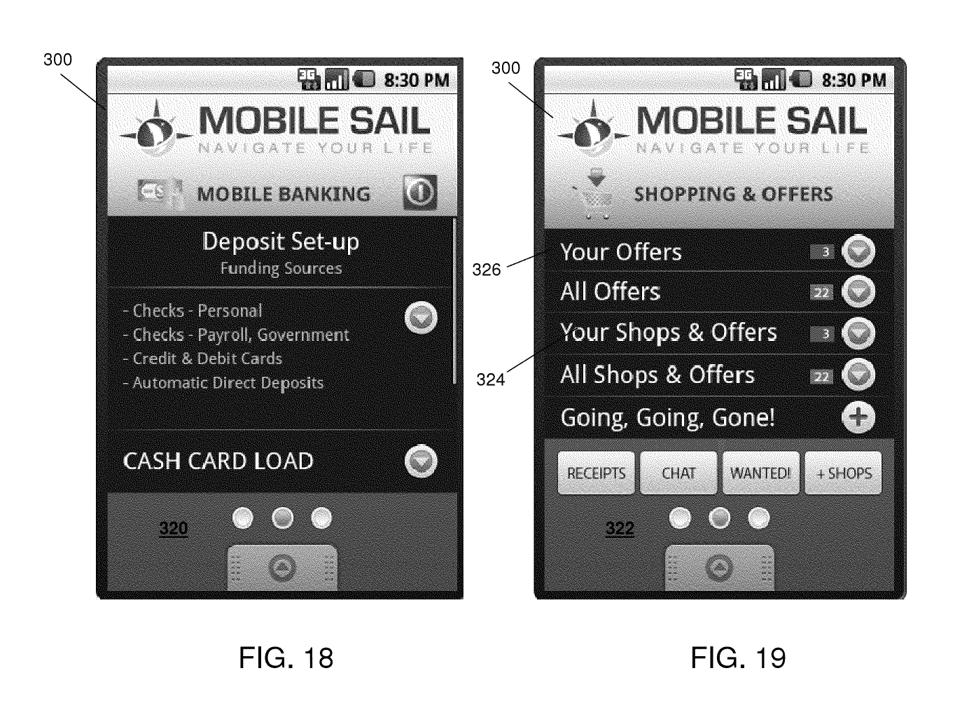

In addition to enabling mobile banking, the CACS 44 can provide user authentication for managing multiple enabled applications 42 using a common user interface. As shown in FIG. 16, a login page 314 can be presented to have the user login in for all mobile banking related activities. FIG. 17 illustrates an example of a mobile banking page 316, which allows balances, deposits, transfers, rewards, etc. be managed from a single application 42. In this example, by selecting the deposits option 318, a page such as that shown in FIG. 18 may be launched. In FIG. 18, a deposit set-up page 320 is shown, which allows, among other things, the user to select a funding source, load a cash card, etc.

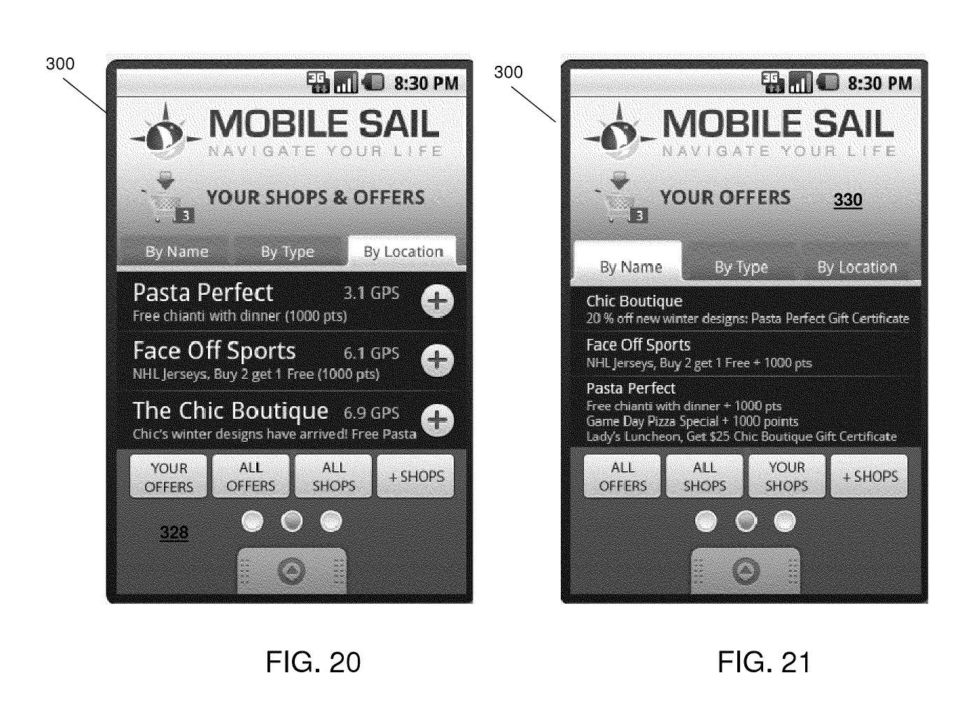

FIG. 19 illustrates a shopping and offers page 322, which may include your offers 326, all offers, your shops and offers 324, all shops and offers, etc. In this example, by selecting the your shops and offers option 324, a page such as that shown in FIG. 20 may be displayed. As shown in FIG. 20, a list of the user's offers and shops is shown in a your shops and offers page 328, in this example, categorized by location. Similarly, by selecting the your offers option 326 in FIG. 19, a your offers page 330 may be displayed as shown in FIG. 21.

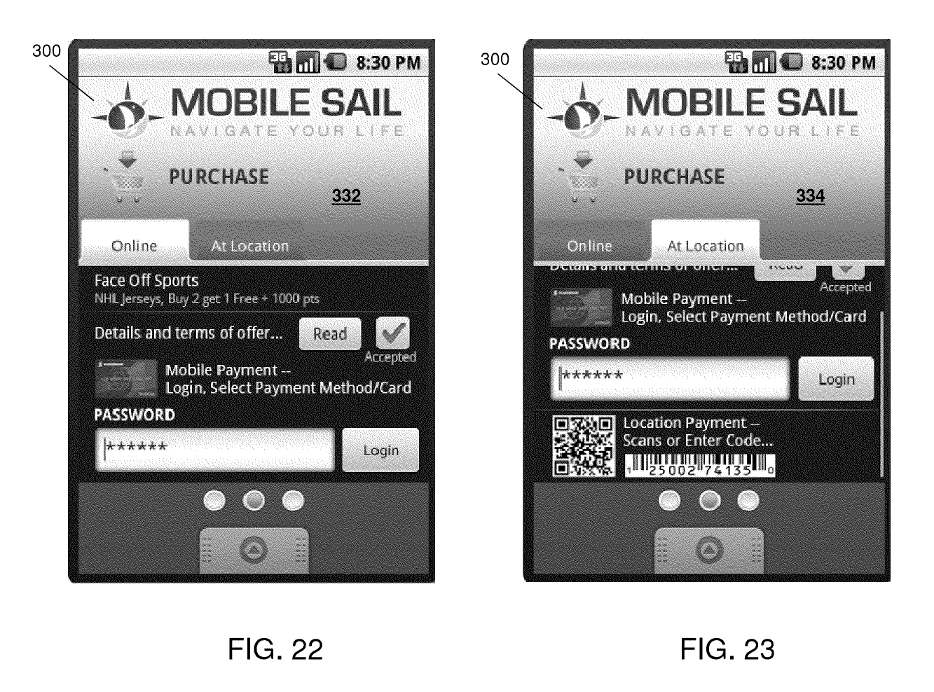

A first purchase page 332 is shown in FIG. 22, which may be used to facilitate an online purchase. A second purchase page 334 is shown in FIG. 23, which may be used to facilitate an at-location purchase, e.g., by enabling barcode scanning, etc.

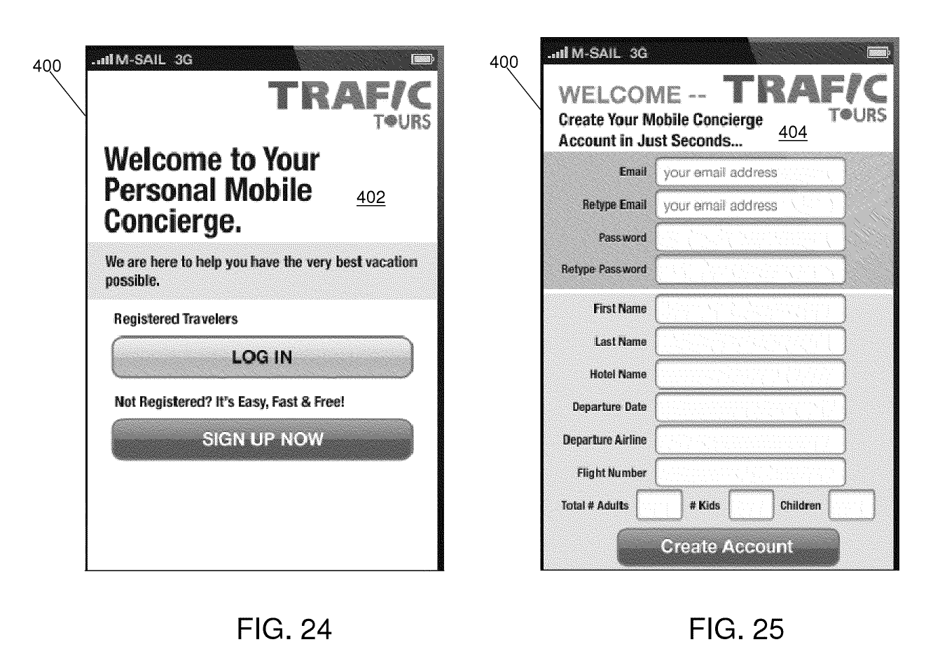

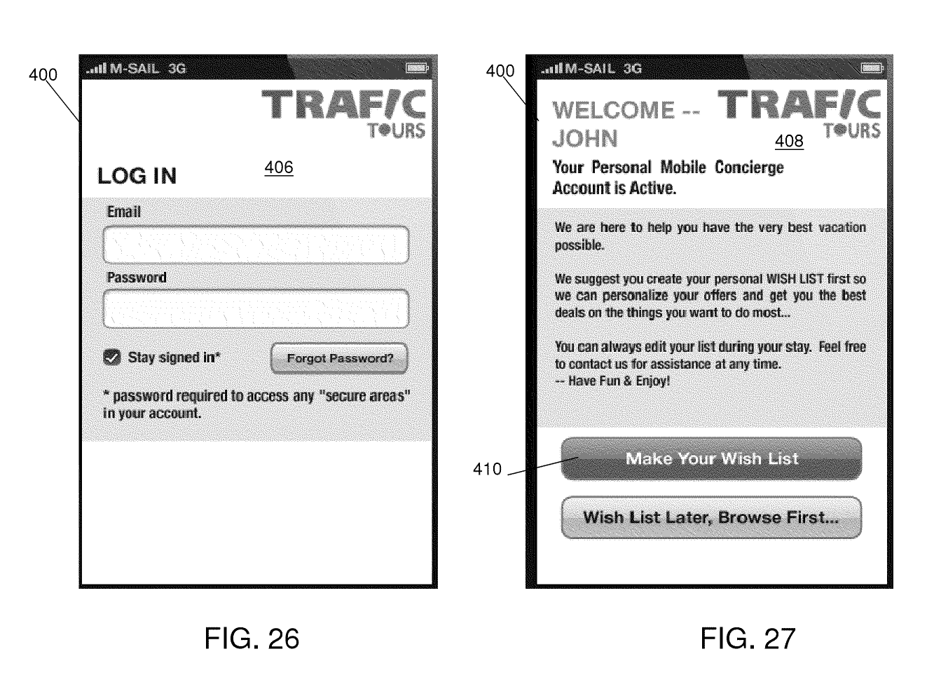

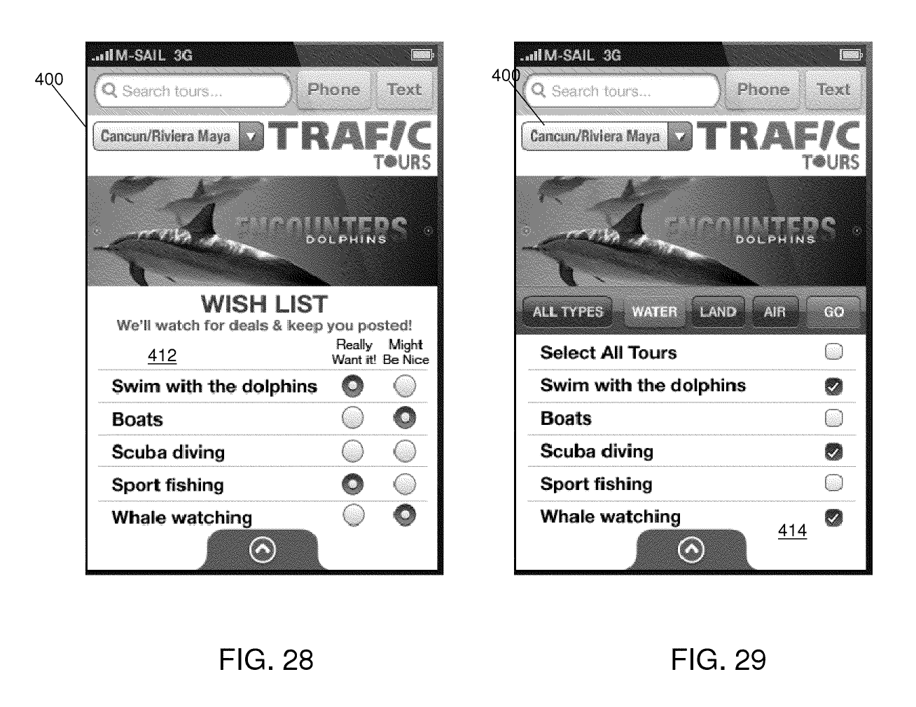

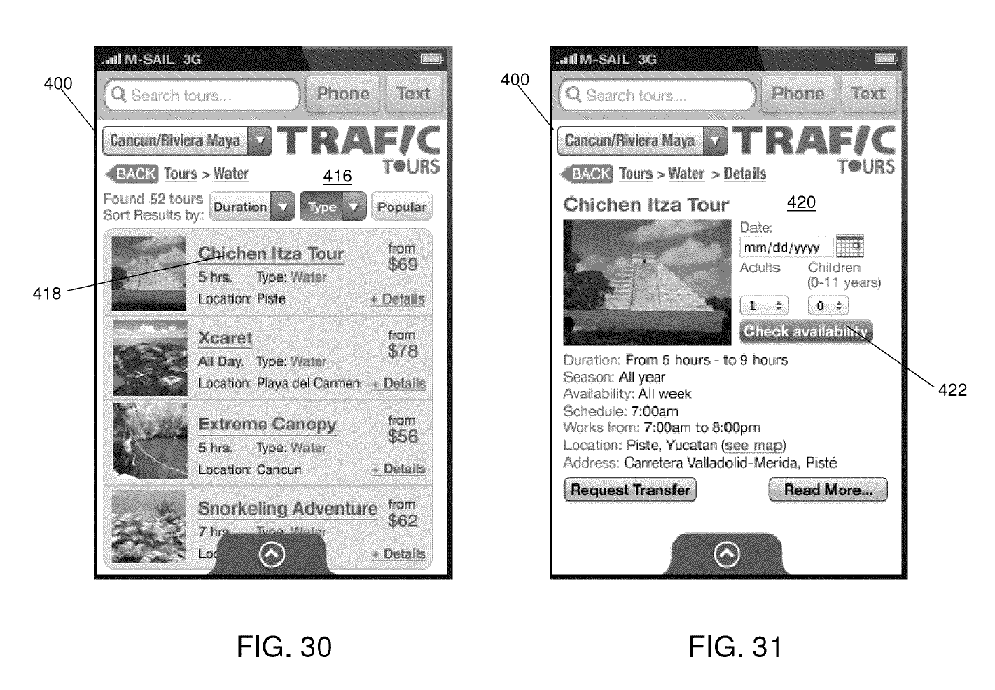

FIGS. 24 to 33 illustrate a travel application user interface 400, which may be loaded onto an electronic device 40 such as a smart phone, when visiting a tourist destination such as a resort. As shown in FIG. 24, a personal mobile concierge page 402 may be displayed to enable a user to log in if already registered, or to sign up. FIG. 25 illustrates a sign up page 404 that enables the user to enter information that can be used to generate activity action elements 17 to enhance the user's visit to the resort. A login page 406 is shown in FIG. 26 to authenticate an existing user. FIG. 27 illustrates a welcome page 408, which include a make your wish list option 410. By selection the wish list option 410, a wish list page 412 such as that shown in FIG. 28 may be displayed to enable the user to select various tours and events they wish to participate in. FIG. 29 illustrates a tours page 414 for managing the items that were selected in creating the wish list or otherwise. FIG. 30 illustrates a tour listing page 416 which pulls together multiple tour offers based on activity action elements 17 to present a list of relevant tours to the user. In this example, by selecting the Chichen Itza tour 418, a tour-specific page 422 is displayed as shown in FIG. 31. The user may then select a check availability option 422 to continue with a booking. It can be appreciated that by selecting a relevant booking, the user's personal goals may then be updated (e.g. using the wish list), and businesses affected by the purchase rewarded. When doing the tour, the user may be required to scan a barcode or otherwise check in to trigger further activity action elements 17 to compensate the appropriate parties.

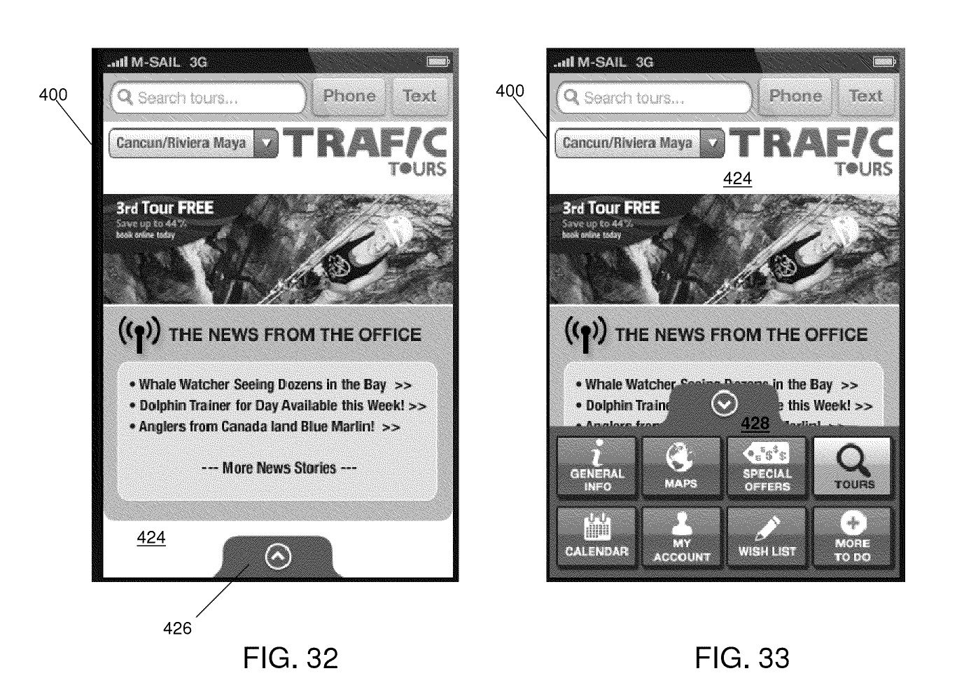

FIG. 32 illustrates a news page 424, providing an example of information that can be pushed to connected users based on activity action elements 17 stored as database entries in the activity action database 26. A tab 426 may be selected as shown in FIG. 32, to pull out a set of options 428 s shown in FIG. 33.

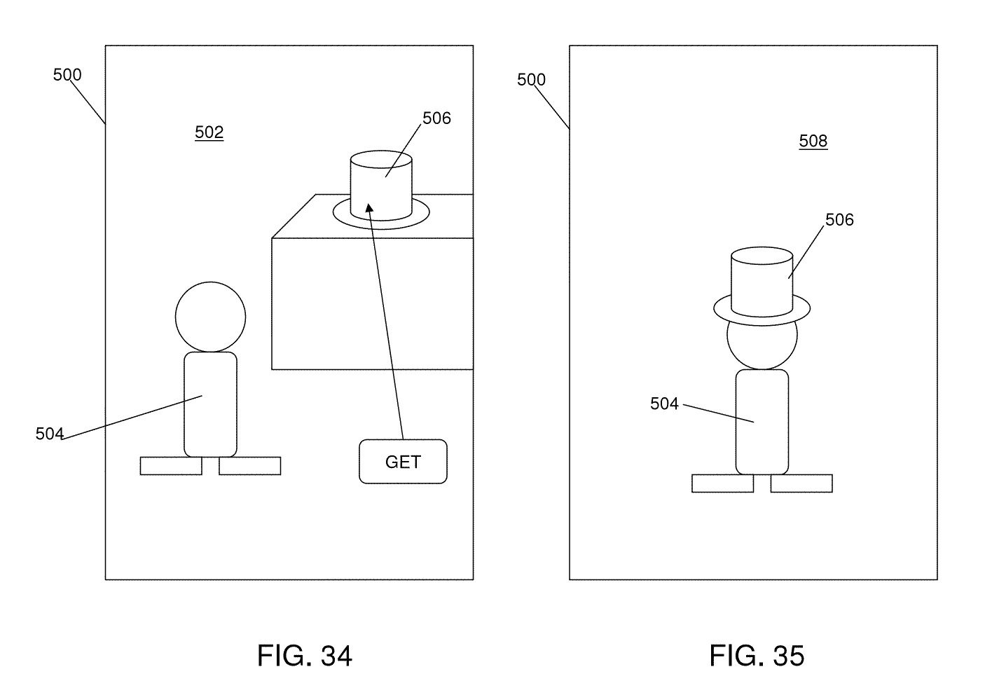

FIGS. 34 and 35 illustrate the application of activity action elements 17 to a game or other virtual environment 500. In the example screen 502 shown in FIG. 34, an avatar 504 gets a hat 506, which corresponds to an activity 16 having associated actions such as wear, color, etc. By getting the hat as shown in FIG. 34, the identity 10 for the avatar 504 may be updated in the activity action database 26 such that thereafter, e.g., a further screen 508 as shown in FIG. 35, the avatar 504 is wearing the hat 506, and the hat has the same properties as the hat 506 obtained in the screen 502. Accordingly, activity action elements 17 can be used not only for user-related activities and commerce but also to change and characterize virtual identities 10. In this way, the avatar 504 can be built in a consistent manner on different devices 40 and even across different applications.

Accordingly, there is provided a method comprising: determining an activity; determining at least one action to be executed in connection with the activity; generating a database entry to include an activity action element specifying the activity and the at least one action; enabling the database entry to be accessed in response to an input; retrieving the activity action element; and executing the at least one action, the at least one action being associated with a mobile application.

There is also provided a computer readable storage medium comprising computer executable instructions for: determining an activity; determining at least one action to be executed in connection with the activity; generating a database entry to include an activity action element specifying the activity and the at least one action; enabling the database entry to be accessed in response to an input; retrieving the activity action element; and executing the at least one action, the at least one action being associated with a mobile application.

There is also provided a system comprising a processor and memory, the memory comprising computer executable instructions for causing the processor to: determine an activity; determine at least one action to be executed in connection with the activity; generate a database entry to include an activity action element specifying the activity and the at least one action; enable the database entry to be accessed in response to an input; retrieve the activity action element; and executing the at least one action, the at least one action being associated with a mobile application.

There is also provided a method comprising: receiving an input; using information in the input to query a database of activity action elements each specifying an activity and at least one action to be executed in connection with the activity, the at least one action being associated with a mobile application; obtaining at least one activity action element from the database; and executing at least a first activity action element.

There is also provided a computer readable storage medium comprising computer executable instructions for: receiving an input; using information in the input to query a database of activity action elements each specifying an activity and at least one action to be executed in connection with the activity, the at least one action being associated with a mobile application; obtaining at least one activity action element from the database; and executing at least a first activity action element.

There is also provided a system comprising a processor and memory, the memory comprising computer executable instructions for causing the processor to: receive an input; use information in the input to query a database of activity action elements each specifying an activity and at least one action to be executed in connection with the activity, the at least one action being associated with a mobile application; obtain at least one activity action element from the database; and execute at least a first activity action element.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the electronic device 40, application 42, CACS 44, activity action database 26, or any component of or related to these entities, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method comprising:
determining an activity;
determining at least one action to be executed in connection with the activity;
generating a database entry to include an activity action element specifying the activity and the at least one action;
enabling the database entry to be accessed in response to an input;
retrieving the activity action element; and
executing the at least one action, the at least one action being associated with a mobile application.

2. The method of claim 1, further comprising including at least one identity in the database entry, the input being associated with one or more of the at least one identity.

3. The method of claim 2, the database entry further specifying a role for the at least one identity in a group of identities.

4. The method of claim 1, further comprising querying the database for other database entries having associated identities that match a characteristic of the activity, and sending information to the associated identities to have further activity action elements executed.

5. The method of claim 4, further comprising detecting an interaction with the information, and executing a further activity action element in response to the interaction.

6. The method of claim 1, the activity being generated during an activation of a new application or a new identity.

7. The method of claim 1, the activity being called upon invoking an application enabled to use the activity action element.

8. The method of claim 1, further comprising updating at least one other activity action element in a post processing phase according to the at least one action.

9. The method of claim 1, being performed by a cross application communication system connectable to a plurality of mobile applications configured to be accessed by a plurality of electronic devices.

10. A method comprising:
receiving an input;
using information in the input to query a database of activity action elements each specifying an activity and at least one action to be executed in connection with the activity, the at least one action being associated with a mobile application;
obtaining at least one activity action element from the database; and
executing at least a first activity action element.

11. The method of claim 10, the input being received by a cross application communications platform from a mobile application, the method further comprising sending application data to the mobile application in association with the executed first activity action element.

12. The method of claim 11, the input associated with any one of: activation of the mobile application, download of the mobile application, and invocation of the mobile application.

13. The method of claim 10, the input being received by a cross application communications platform from a business organization, the method further comprising determining an identity associated with the first activity action element, and sending application data to the identify having the mobile application in association with the executed first activity action element.

14. The method of claim 10, further comprising:
determining a second activity based on execution of the first activity action element;
determining at least one action to be executed in connection with the second activity; and
generating a database entry to include a second activity action element specifying the second activity and the at least one action.

15. The method of claim 15, further comprising:
enabling the database entry to be accessed in response to a further input; and
retrieving the new activity action element and executing the new activity action element.

16. A computer readable storage medium comprising computer executable instructions for:
determining an activity;
determining at least one action to be executed in connection with the activity;
generating a database entry to include an activity action element specifying the activity and the at least one action;
enabling the database entry to be accessed in response to an input;
retrieving the activity action element; and
executing the at least one action, the at least one action being associated with a mobile application.

17. A system comprising a processor and memory, the memory comprising computer executable instructions for causing the processor to:
determine an activity;
determine at least one action to be executed in connection with the activity;
generate a database entry to include an activity action element specifying the activity and the at least one action;
enable the database entry to be accessed in response to an input;
retrieve the activity action element; and
executing the at least one action, the at least one action being associated with a mobile application.

18. A computer readable storage medium comprising computer executable instructions for:
receiving an input;
using information in the input to query a database of activity action elements each specifying an activity and at least one action to be executed in connection with the activity, the at least one action being associated with a mobile application;
obtaining at least one activity action element from the database; and
executing at least a first activity action element.

19. A system comprising a processor and memory, the memory comprising computer executable instructions for causing the processor to:
receive an input;
use information in the input to query a database of activity action elements each specifying an activity and at least one action to be executed in connection with the activity, the at least one action being associated with a mobile application;
obtain at least one activity action element from the database; and
execute at least a first activity action element.
